(19) United States
(12) Patent Application Publication
(10) Pub. No.: US 2005/0061928 A1
(43) Pub. Date: Mar. 24, 2005

(54) Method for introducing an assembly for housing at least one optical conductor into a road and cable laying device comprising a cable assembly that contains an optical conductor

(76) Inventor: Lothar Finzel, Unterschleissheim (DE)

Correspondence Address: Timothy J Aberle, PO Box 489, Hickory, NC, 28603-0489, US

(21) Appl. No.: 10/499,951

(22) PCT Filed: Dec. 13, 2002
(86) PCT No.: PCT/DE02/04572

(30) Foreign Application Priority Data
Dec. 21, 2001 (DE) 101 63 464.1
Sep. 16, 2002 (DE) 102 42 939.1

(51) Int. Cl. F16L 3/08

(52) U.S. Cl. 248/74.5

(57) ABSTRACT

A configuration containing at least one optical core is placed into a street formed by a top layer and a flat sub-layer located underneath. The configuration is applied positioned on a surface of the sub-layer and the top layer is subsequently applied in a flat manner, so that the configuration is embedded in the top layer. The installation of the configuration takes place with comparatively low cost, since no earth removal work or underground work is necessary. The invention is especially advantageous when the street surface has to be renovated anyway.

### FIELD OF THE INVENTION

The present invention concerns a process for placement of a configuration for reception of at least optical core into a street as well as a cable installation configuration, which shows a cable configuration containing at least one optical core, which is placed into a street.

### BACKGROUND OF THE INVENTION

It is usual for certain application, to place a cable, for example in the form of an optical cable or cable configuration, respectively, for installation into a canal or into a firm installation base. For installation, the selection is generally between two options. In the first option, the optical cable is directly installed into the canal or installation base during the installation process. In the second option, an empty ductwork is first installed in the respective canal or installation base. The optical cable or the optical fibers, respectively, as well as fiber elements are subsequently placed into the respective empty ductwork.

In WO 97/20236 a process for placement of an optical cable into a firm installation base, especially in the form of a street, by means of an installation unit is described. As the optical cable, a so-called micro or mini-cable, respectively, is installed, which consists of a homogenous water pressure tight duct with a an outer diameter of 2.0 to 10 mm, into which optical fibers are placed. For installation of the micro- or mini-cable, respectively, an installation groove, with a width adjusted to the diameter of the micro- or mini-cable, respectively, of 4.5 to 12 mm is milled into the firm installation base by means of a milling wheel arranged within the installation unit. The work processes of milling, installing and sealing of the groove can be done immediately one after the other, where they are executed in one work process by a machine combination. In this way a comparatively quick installation without appreciable traffic interruption is possible; however, the process connected to earth removal tasks is comparatively costly and the abovementioned machine is comparatively expensive to manufacture.

The present invention has the objective to specify a process for the placement of a configuration for reception of at least one optical core in a street, which only requires a comparatively small investment for the installation of the configuration.

Additionally, it is the objective of the present invention, to specify a cable installation configuration, which shows a cable configuration containing at least one optical core, which is placed into a street, and which distinguishes itself by the fact, that the cable configuration to be installed can be placed in a comparatively simple manner.

The objective concerning the process is achieved by a process according to patent claims 1 and 2. The objective concerning the cable installation is achieved by a cable installation configuration according to patent claims 11 and 12.

According to the process according to the invention the configuration receiving a configuration containing at least one optical core is placed into a street formed by a top layer of ballast and a flat sub-layer beneath it, where the configuration is applied to a main surface or into a depression of the sub-layer significantly greater than the configuration and the top layer is subsequently applied in a flat manner, so that the configuration is embedded into the top layer. Thus the invention has the advantage, that no additional earth removal or underground work is necessary. The configuration can be applied to the surface of the sub-layer still exposed by means of simple machines or even by hand. Subsequently, the top layer, especially in the form of an asphalt layer of a street, is applied in a flat manner.

The invention is especially advantageous, when the street surface has to be repaired due to signs of wear and tear. In such a case the old top layer of the street is most often milled down to a sub-layer, especially a base layer of a street; subsequently the configuration is applied to the surface of the sub-layer and then the street is newly asphalted, so that the top layer is applied and the configuration is embedded in the top layer. It is advisable to connect the cable firmly with the sub-layer before applying the top layer. In this way the cable is anchored and has the same depth relative to the surface of the sub-layer.

The able is optimally protected against mechanical stresses, climate and temperatures by the top layer or asphalt cover, respectively, of the street. By appropriate selection of materials in the cable configuration, the position of the cable can easily be calibrated later by means of common inductive measurement process. By applying the configuration directly to the surface of the exposed sub-layer a quick and economical installation of the configuration is possible. Since a large installation surface is generally available if a street is resurfaced, when it stretches for example over the width of a traffic lane on an interstate, large bending radii during installation of the configuration are possible. Thus the friction during subsequent insertion into ductwork is greatly reduced. This results in the advantage, that a cable can be placed subsequently into an installed cover or duct over comparatively long distances.

An additional advantage over the initially described installation technology, where a separate installation groove is milled into a firm base, results from the fact, that the top layer can be applied to a larger surface after the application of the configuration to the sub-layer, so that for example a traffic lane formed by the top layer is constructed over a large surface from a uniform layer. Against the initially described sealing of the installation groove with a width of 4.5 to 12 mm adjusted for the diameter of a micro- or mini-cable, respectively, the invention provides that the top layer is applied in a flat manner unto the surface of the sub-layer, especially over the width of a conventional traffic lane of a street, a shoulder or a side strip, and the configuration for the reception of the optical core is embedded in it.

A processing temperature of hot asphalt, which preferably form the top layer, is commonly between 170 and 210° C. Correspondingly, for the purposes of the invention, a cover or duct, which receives the optical core, is selected in such a way, that it has a temperature resistance of at least 170° C. The cover or duct consists preferably of temperature-resistant plastic, which is designed for the indicated temperatures, so that the cover or duct does not collapse or explode, when it is for example filled with a gel-like material for longitudinal water resistance.

Other advantageous materials for a cover or duct are carbon ceramics or metal, where copper should be especially emphasized. Copper in general has a sufficiently high traverse pressure resistance and good temperature conducting ability. It can be processed and installed very well. Due to the very good temperature conducting ability, a partial, short-time heating is well dissipated. In case the optical core is already contained during the placement of the configuration, the contained optical fibers and filling compounds are not heated over a maximum allowable temperature limit, if a metal tube, preferably a copper tube is used, when the configuration is covered by the hot asphalt layer of a new street layer. This is also true in case the street and the cable configuration are heated perhaps due to an accident.

In a construction form of the process according to the invention, a cover or duct of the configuration is applied to the main surface of the sub-layer and the optical fiber is subsequently placed in the installed cover or duct. The placement can be done for example by blowing in, pulling in or flushing in using a liquid medium. The placement of the optical fibers after installation of the cover or duct has the advantage, that the characteristics of the optical fiber do not have to be considered during application of the top layer and the high temperatures connected with this, when the optical fiber is not yet contained in the cover or duct during application of the top layer. A temperature-resistant cover or duct, such as plastic, ceramic, asbestos cement or such can be used, which show a lesser heat conducting ability than metal, since the maintenance of a temperature limit within the cover is not relevant during application of the top layer.

In another construction form of the process according to the invention, the optical core is already contained in the configuration during placement of the configuration. During installation it has to be observed, that the optical core, which especially has a coated optical fiber, generally has a temperature limit. The temperature limit generally is the temperature, where the coating of the coated optical fiber separates from the fiber or when chemical or physical characteristics of the coating are changed. Temperatures above the temperature limit damage the coating of the optical fiber permanently. Accordingly, the cover or duct in a construction form according to the invention are selected in reference to temperature resistance and heat conducting ability in such a way and the top layer applied over a length of the cover or duct in such a way, that the temperature limit of the optical core is not exceeded at any point of the optical core. The described temperature limit of an optical core for presently common production is approximately 85° C. During application of the top layer care has to be taken, that over the length of the cover or duct there are always areas of the cover or duct, where the temperature lies below the temperature limit, so that quick heat dissipation from areas of the cover or duct with higher temperatures is ensured and thus the temperature limit inside the ducts is not exceeded.

When the street surface is renovated for example by milling down, the configuration for the reception of the optical core is directly applied to the milled street surface. The application of the configuration onto the main surface of the exposed sub-layer is advantageously executed with one holding element, for example a anchoring clamp, so that the configuration is held in place, before the new top layer is applied. Anchoring clamps are preferably anchored into the asphalt cover of the sub-layer with long nails or screws. These can be hammered in, shot in or screwed in. The configuration for the reception of the optical core must be sufficiently anchored, so that it does not separate, whenever for example construction vehicles roll over it. The load capacity against shearing effect and traverse pressure of the configuration has to be ensured in such a way, that sufficient strength against mechanical stress by the construction vehicles and during packing of the top layer by stamping and steamroller vehicles exists.

In a further advantageous construction form of the process according to the invention the configuration comprises at least two covers or ducts, where at least one of them receives the optical core, where they are anchored on the main surface of the sub-layer with at least one holding element, which keeps the covers or ducts in the complex in position. By providing several individual ducts or covers, access to the individual ducts or covers, respectively, is possible without having to open the others. By anchoring in the complex by means of a holding element a compact complex is present.

In a further advantageous construction form of the process according to the invention the configuration is configured with at least one barrier formed as a temperature shield on the main surface of the sub-layer, in order to protect the configuration against mechanical and thermal stress, when the top layer is applied. The barrier distinguishes itself by low heat conducting ability against the cable configuration. Thus the cable or pipes beneath it heat up slowly, when the top layer is applied.

Further advantageous constructions and developments of the invention are given in the sub claims.

### BRIEF DESCRIPTION OF THE FIGURES

The invention is more closely explained in the following by means of the figures depicted in the diagrams, which depict the construction forms of the present invention. Shown are:

FIG. 1 a cross-section of a construction form of a cable installation configuration according to the invention,

FIG. 2 a view from above of a construction form of a configuration for installation of an optical core during installation,

FIGS. 3 to 7 one cross-section diagram each of different variations and construction samples for installation and embedding of pipes or cables, respectively, into the asphalt layer of a street surface,

FIG. 8 a view from above of a further construction form of a configuration for installation of an optical core during installation,

FIG. 9 a schematic cross-section of an installation configuration with a cable in a wide depression.

### DETAILED DESCRIPTION OF THE INVENTION

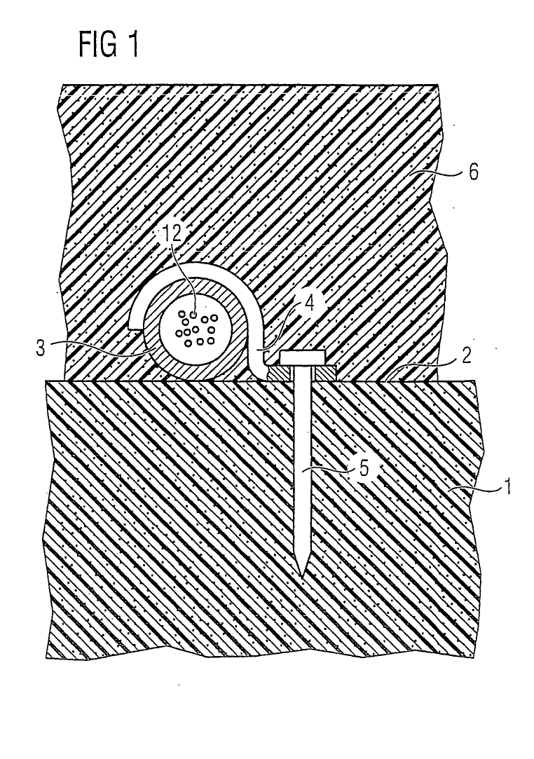

FIG. 1 shows a schematic cross-section of a cable installation configuration, where a cable configuration is placed into a street. The cable configuration shows a pipe 3, which shows optical cores in the form of coated optical fibers 12. The street shown in FIG. 1 as a section is formed by a sub-layer 1, which is essentially level and flat, and by a top layer 6 applied on top of it, especially in the form of an asphalt layer, which serves for example as a traffic lane and is made of bitumen. The cable configuration of pipe 3 and fibers 12 is situated on the main surface 2 of the sub-layer 1 and is embedded in the top layer 6. The pipe 3 then is anchored by a holding element 4 in the form of a metal clamp. A metallic anchoring clamp ensures good stability of the anchoring of pipe 3, when it is embedded during the application of the hot top layer 6. The clamp 4 is anchored by a nail or a screw S into the sub-layer 1.

In order to ensure good durability of the street complex made up of top layer and sub-layer, the ratio of the thickness of the top layer 6 to a diameter of pipe 3 should be at least 4:1. Pipe 3 for example has a diameter of 7 mm. Good durability is ensured, when the top layer 6 in this case has a thickness of approximately 4 cm.

Preferably so-called micro- or mini-cables, respectively, with a correspondingly adjusted diameter (f.e. 4.5 to 12 mm) can be used. Such a comparatively small cable essentially does not influence the construction and the load bearing ability of the new top layer 6.

Pipe 3 is made of metal, preferably copper, so that the fibers 12 are protected, especially in view of temperature stress during the application of the top layer 6. A metal pipe ha sufficient traverse pressure stability, temperature stability and good heat conducting ability. Thus a small, robust, cable resistant to buckling, stable against traverse pressure and waterproof is available for installation in rough surroundings. The metal pipe 3 can be crossed by construction vehicles before the application of top layer 6. Due to good heat dissipation, overheating of contained optical cores during application of the top layer is avoided. In this regard the high heat capacity is an advantage, which can be obtained through high copper percentage in the pipe. Additionally, good rodent protection is created.

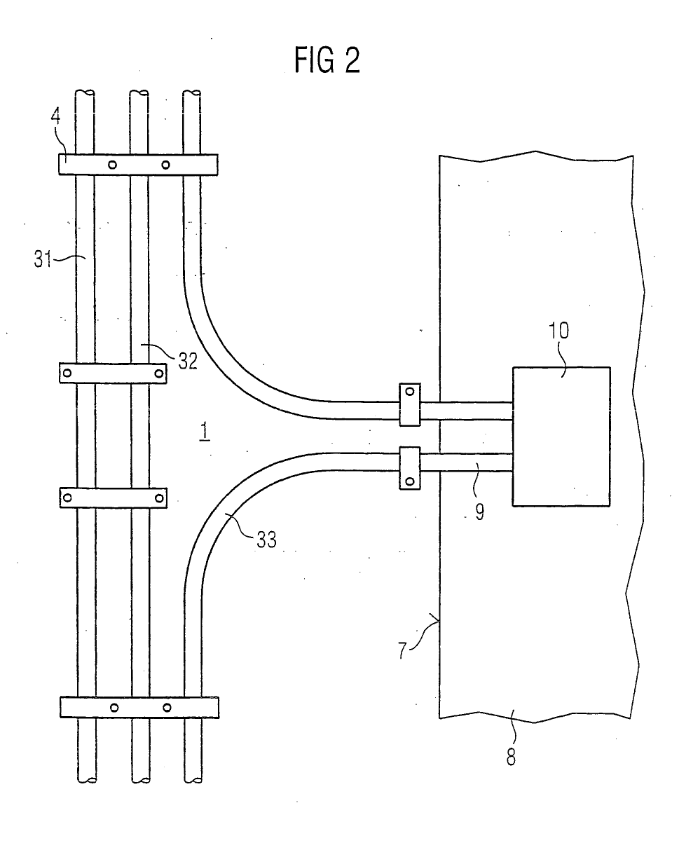

FIG. 2 shows in a schematic diagram, how a micro-cable or ductwork is installed on the exposed street surface and is branched. The street depicted is limited on the side by a side strip 7 and a curb 8. In the course of a traffic lane renovation the upper top layer of the street is milled down, so that the sub-layer 1 is exposed. Onto the main surface of the flat sub-layer 1 several metal pipes are applied and anchored with clamps 4. In the present example it is assumed, that several optical cores are already contained in metal pipes 31 and 32.

By installing onto the main surface of the sub-layer 1 of the street it is possible to execute a change in direction of the pipes with a comparatively large arc, shown in the diagram with pipe 33. At a branching point 9, pipe 33 is connected to a sleeve 10. Installing in a large arc, for example with a radius greater than 160 times the diameter of pipe 33, facilitates a later blowing in of optical cores into pipe 33. The metal pipe 33 also provides mechanical protection when moving them into the sleeve 10.

When the installation is thus complete, a top layer is applied in a flat manner to the main surface of the sub-layer 1 during the traffic lane renovation, so that the individual metal pipes are embedded in the top layer. Since the metal pipes 31 and 32 in the sample already contain optical fibers, care has to be taken, that the top layer is applied along the length of the pipes 31 and 32 in such a way, that the temperature limit of 85° C., at which the coating of the optical fibers of the cores separates, for the optical cores in the pipes is not exceeded at any point in the cores. Due to the good heat conducting ability of the metal pipes this can be especially ensured, if the top layer is applied in several steps over several segments, so that some areas of the pipes are always exposed, which have a comparatively low temperature.

In case the optical cores are placed into the respective metal pipe after application of the top layer, such a process is not necessary. Here a temperature stability of the installed ductwork of at least 170° C. is sufficient, since this generally corresponds to the processing temperature of hot asphalt (processing temperature approximately 170° C. to 210° C.). The cooling of the asphalt from 170° C. to 85° C. takes generally at least one hour. Ductwork can be made of temperature resistant plastic or carbon ceramic. By using a plastic pipe better stability against temperature increases and deformation by cooling the interior space with air, water or dry ice, or by filling the interior space for example with sand to improve stability. After installation, the filling is removed, for example by means of a wire or such.

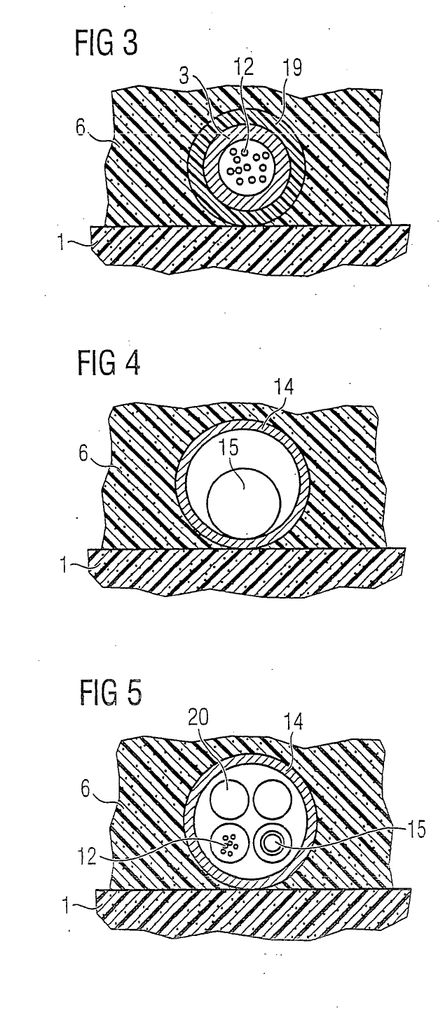

FIG. 3 shows a schematic cross-section of the installation of a micro-cable onto the main surface of a sub-layer 1. The cable has a copper cover 3, which contains the optical cores with the optical fibers 12. The copper cover 3 thus forms an interior layer of the cable in the direction of the optical fibers. Additionally the micro-cable shows an outer layer 19 in the form of a cable jacket made of plastic. The cable jacket made of plastic serves preferably as a means of separation, in case the cable has to be removed from the street layer at a later time. For this purpose a cable jacket or outer layer, respectively, is to be provided, which has a lower adhesion to the inner layer, here in the form of copper cover 3, than to the top layer 6 of the street. Thus the cable together with the inner layer in the form of the copper cover 3 can easily be peeled out, since the adhesion to the outer layer is comparatively lower than to the top layer of the street. Cable jacket 19 for example is made of PE or HDPE plastic, which begins to melt during application of the hot top layer 6. A “normal” plastic jacket made of PE or HDPE softens at temperatures of 120° C. to 140° C.

FIG. 4 shows a further schematic cross-section of an installed ductwork 4, which is located on the sub-layer 1. A thin cable 15 is subsequently pulled in the ductwork 14. The ductwork 14 preferably shows a layer, oriented towards the cable 15, which for example contains Teflon for avoiding friction.

FIG. 5 shows a further cross-section diagram of an installed pipe 14 with a larger diameter. Pipe 14 is divided into so-called subducts by several smaller pipes 20. As needed single fibers or fiber elements 12 or very small cables can be blown into them.

FIG. 6 shows several cable configurations in a schematic cross-section diagram, which differentiate themselves mainly in the construction form of the metal pipes. Pipe 16-a is formed as a longitudinally welded metal pipe, which contains individual fibers 17 and fiber elements 18, which show several individual fibers. The metal pipes 16-b and 16-c, which each contain 17 fibers, are each made of a formed metal band, where the ends of the band overlap at the connection point. In this way a comparatively economical manufacture of the metal pipes is made possible. Since the pipes, as shown in FIG. 2, can be installed with comparatively large arcs, the overlapping fold of the metal pipes has no negative influence on the freedom of installation or the susceptibility to buckling of the pipes. The fibers or fiber elements, respectively, contained in the metal pipes depicted can be blown in after street renovation.

FIG. 7 shows a further schematic cross-section diagram of a very thin installed duct, for example pipes 31 and 32, which are applied to the main surface of the sub-layer 1. Here the pipes are combined in a so-called flat ribbon. A collection chamber 23 keeps the pipe complex in position. After the renovation of the street, individual fibers or fiber elements can be blown into these small pipes.

In a further construction form according to FIG. 7, an element 29 is provided as a barrier between the pipes 31, 32 and the top layer 6, which protects the cable against mechanical and thermal stress. The barrier 29 shows heat-suppressing material, especially asbestos cement, asbestos cardboard or mineral wool. The barrier is preferably coated with metal on one side for improvement of heat dissipation. The barrier 29 is anchored to the surface or is glued to the surface. With poor temperature dissipation to the cable or pipe, their heating is slowed down. With appropriate thickness of the barrier 29 the pipes 31, 32 located below it warm up very slowly.

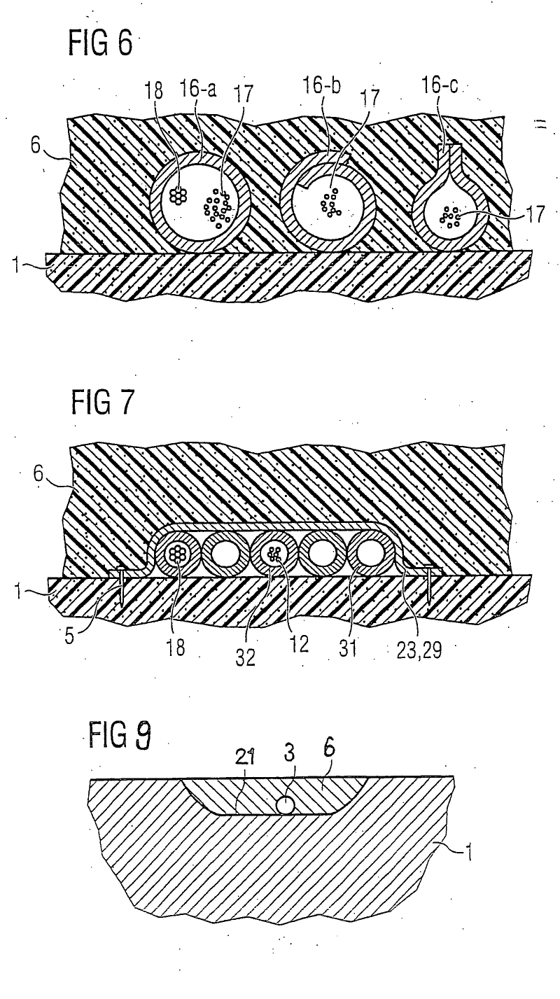

Similar to FIG. 2, FIG. 8 depicts a schematic view from the top of the configuration of several pipes 31 to 33 on the main surface of the sub-layer of the street shown. As in FIG. 7, several pipes are shown combined into a flat ribbon. It is also shown, how pipe 33 is led out in the middle and is branched at the side into a shaft. Since the diameters of the pipes 31 to 33 are very small relative to the thickness of the subsequent top layer (with a ratio preferably 1:4), the static of the street is not influenced in a negative way. The pipe 33 is led out in a large arc. This creates a free space 24, which is not occupied. A gradual rise of pipe 33 out of the complex at point 26 enables a soft transition. To avoid buckling of the pipe during application of the later top layer, it is supported with a height compensation 27 and an anchoring 28. The pipe 33 is again lowered to the height of the sub-layer of the street after the rise.

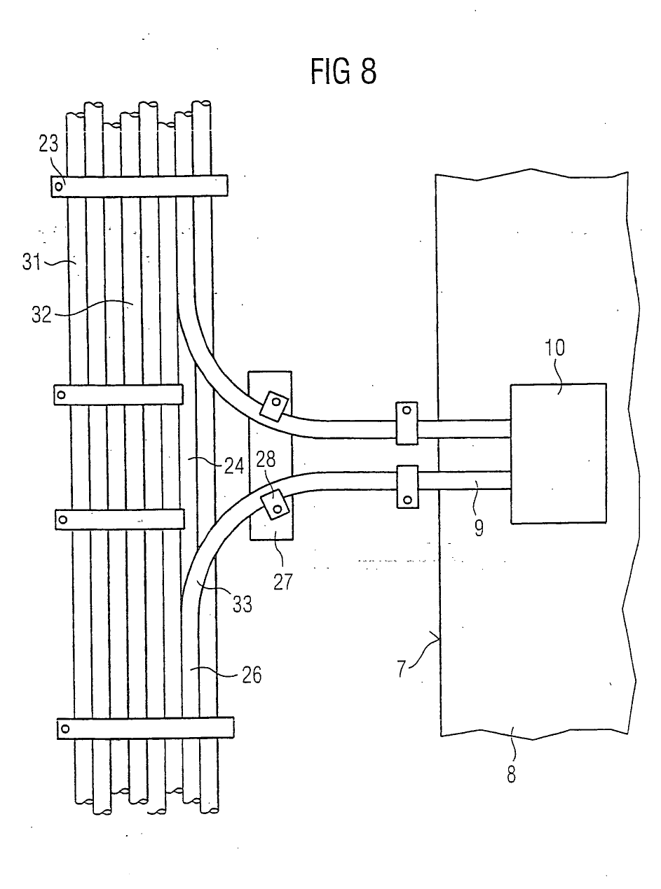

FIG. 9 show a schematic cross-section of an installation configuration, where a cable 3 is located in a wide depression 21 in the surface. Cable 3 is preferably a so-called micro- or mini-cable, respectively, with a diameter of approximately 4.5 to 12 mm. Such a comparatively small cable essentially does not influence the construction and the bearing capacity of a new top layer. In the sample according to FIG. 9, the depression 21 has a depth of approximately 40 mm and a width of approximately 250 mm.

Generally the depression should have a width across the installation direction, which is greater than ten times the diameter of the installed cable. This improves the adhesion of the asphalt applied later in the form of a top layer 6. Additionally, the adhesion of the asphalt is improved by abrasion of the street surface. Since a depression is cut into the street surface, which is significantly wider than the cable to be installed, the mechanical characteristics of the street surface are maintained; additionally, coarse grained asphalt can be used to fill the depression.

1. Process for the placement of a configuration for reception of at least one optical core into a street formed by a top layer and a flat sub-layer located beneath it, where the configuration is applied positioned on the main surface of the sub-layer and where subsequently the top layer is applied in a flat manner, so that the configuration is embedded in the top layer.

2. Process for the placement of a configuration for reception of at least one optical core into a street formed by a top layer and a flat sub-layer located beneath it, where the configuration is applied positioned in a depression of the sub-layer onto a surface of the sub-layer and where subsequently the top layer is applied in a flat manner, so that the configuration is embedded in the top layer, where the depression has a width across the installation direction, which is significantly larger than a diameter of the configuration.

3. Process according to claim 1, wherein the configuration being comprised of at least one cover or duct, which is applied to the surface of the sub-layer, and the optical core then being placed into the installed cover or duct.

4. Process according to claim 3, wherein the optical core being blown into, pulled into or flushed into the installed cover or duct by means of a liquid medium.

5. Process according to claim 1, wherein the optical core already being contained in the configuration during placement of the configuration.

6. Process according to claim 5, wherein a cover or duct, which receives the optical core, being selected with reference to temperature stability and heat conducting ability and the top layer being applied over the length of the cover or duct in such a way, that a temperature limit of the optical core, at which the coating of a coated optical fiber of the core separates from the fiber, is not exceeded at any point.

7. Process according to claim 6, wherein the cover or duct being selected and the top layer being applied in such a way, that a temperature limit of the core of approximately 85° C. is not exceeded.

8. Process according to claim 1, wherein the configuration being anchored to the surface of the sub-layer with a least one holding element, in order to keep the configuration in position before the top layer is applied.

9. Process according to claim 8, wherein the configuration comprising at least 2 covers or ducts, at least one of which receives an optical core, being anchored to the surface of the sub-layer by at least one holding element, which keeps the cover or duct complex in position.

10. Process according to claim 1, wherein the configuration being configured with at least one barrier, which is formed as a temperature shield, on the surface of the sub-layer, in order to protect the configuration against mechanical and thermal stress, when the top-layer is applied.

11. Cable installation configuration, which shows a cable configuration containing at least one optical core, which is placed into a street formed by a top layer and a flat sub-layer located beneath it, where the cable configuration is positioned on a main surface of the sub-layer and is embedded in the top layer.

12. Cable installation configuration, which shows a cable configuration containing at least one optical core, which is placed into a street formed by a top layer and a flat sub-layer located beneath it, where the cable configuration is located in a depression of the sub-layer on a surface of the sub-layer and is embedded in the top layer, where the depression shows a width across the direction of the cable configuration, which is significantly greater that a diameter of the cable configuration.

13. Cable installation configuration according to claim 11, wherein the cable configuration showing a cover or duct, which contains the optical core, where the cover or duct has a temperature stability of at least 170° C.

14. Cable installation configuration according to claim 11, wherein the cover or duct being made of plastic, carbon ceramic or metal, especially copper.

15. Cable installation configuration according to claim 11, wherein the cable configuration showing a cover or duct, which contains the optical core and showing an inner layer and an outer layer, where the outer layer has a lower adhesion to the inner layer than to the top layer of the street.

16. Cable installation configuration according to claim 11, wherein the cable configuration showing a cover or duct, which contains the optical core and a ratio of the thickness of the top layer to a diameter of the cover or duct being at least 4:1.

17. Cable installation configuration according to claim 11, wherein the cable configuration showing a cover or duct, which contains an optical core and showing a layer containing Teflon oriented towards the optical core.

18. Cable installation configuration according to claim 11, wherein the cable configuration showing a cover or duct, which contains an optical core and being produced from a formed band with overlapping band ends.

19. Cable installation configuration according to claim 1, wherein a barrier being provided between the cable configuration and the top layer, which protects the cable against mechanical and thermal stress.

20. Cable installation configuration according to claim 19, wherein the barrier having heat-suppressing material, especially asbestos cement, asbestos cardboard or mineral wool.

21. Cable installation configuration according to claim 19, wherein the barrier being coated on one side with metal.
